(19) United States
(12) Patent Application Publication
(10) Pub. No.: US 2008/0040779 A1
(43) Pub. Date: Feb. 14, 2008

(54) System and method for identification verification

(76) Inventor: Allen J. Budzichowski, Burbank, CA (US)

Correspondence Address: CISLO & THOMAS, LLP, 233 WILSHIRE BLVD, SUITE 900, SANTA MONICA, CA, 90401-1211, US

(21) Appl. No.: 10/765,528

(22) Filed: Jan. 26, 2004

Related U.S. Application Data
(60) Provisional application No. 60/463,782, filed on Apr. 17, 2003.

(51) Int. Cl. H04L 9/32

(52) U.S. Cl. 726/5

(57) ABSTRACT

Exemplary embodiments disclosed herein may include a system and method for verifying the identity of a person. A database may comprise user identification information, including an acknowledgement from a government entity, which can be accessed by a merchant or other entity requiring the verification of the identity of a person.

### CROSS-REFERENCE TO RELATED APPLICATIONS

This application claims priority to U.S. Provisional Application Ser. No. 60/463,782 entitled SYSTEM AND METHOD FOR IDENTIFICATION VERIFICATION filed on Apr. 17, 2003, which is incorporated herein by this reference thereto for all purposes.

### BACKGROUND

Identity theft and credit card fraud cost individuals, merchants, and banks millions of dollars every year. There are many systems available to verify identification. What is needed is an extra level of identity information for identity verification.

### SUMMARY

Provided is a system and method for verifying the identity of a user. Exemplary embodiments may include an identification system together with a database containing user identification attributes that include a verification from the Internal Revenue Service, an identification device encoded with one or more of the user identification attributes, a terminal configured to receive the one or more user identification attributes from the identification device and to communicate with the database, where the identification attributes from the identification device and the database are compared to verify the identity of the user.

### BRIEF DESCRIPTION OF THE DRAWINGS

FIG. 1 is a block diagram of a system according to one exemplary embodiment.

FIG. 2 is a flow diagram of a method according to an exemplary embodiment.

### DESCRIPTION OF EXEMPLARY EMBODIMENT(S)

The description set forth below in connection with the appended drawings is intended as a description of exemplary embodiments and is not intended to represent the only forms in which the embodiments may be constructed and/or utilized. The description also sets forth the functions and the sequence of steps for constructing and operating the illustrated embodiments. However, it is to be understood that the same or equivalent functions and sequences may be accomplished by different embodiments that are also intended to be encompassed within the spirit and scope of the invention.

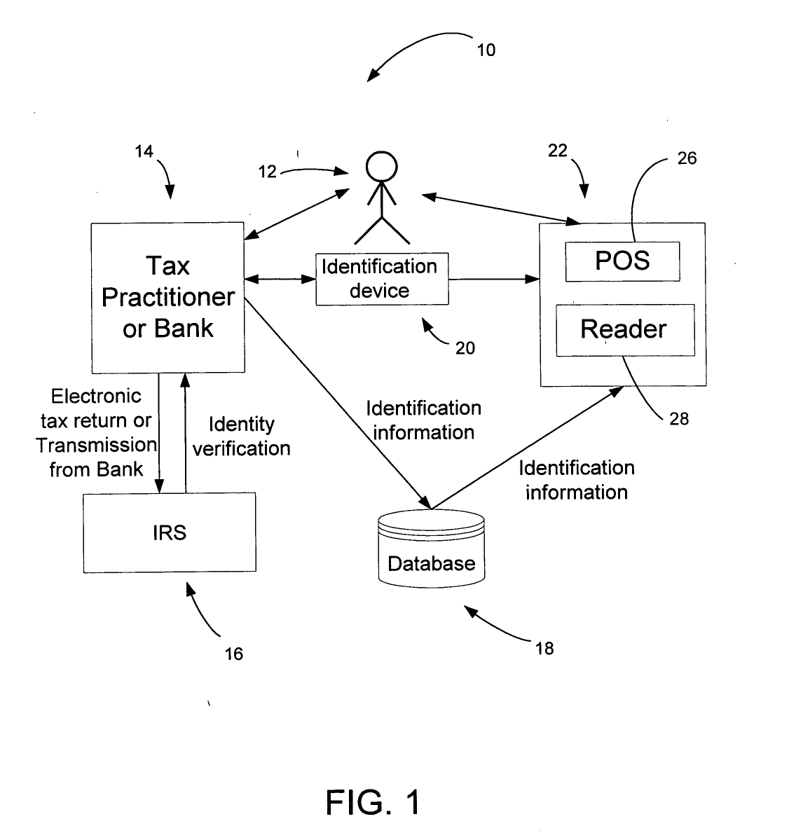

A system according to an exemplary embodiment is shown in FIG. 1, generally at 10. System 10 may include a user 12. User 12 may go to a tax practitioner 14 to have their income taxes prepared and electronically filed, or to a bank 14 to open a deposit or loan account or other type of account. The tax practitioner 14 may transmit the electronic return to a government agency, such as the IRS 16, which in turn may verify the social security numbers and identities of every person included in the tax return. The bank 14 may transmit identification information of a user 12 to a government agency, such as the IRS 16, which in turn may verify the social security numbers and identities of every person included on the account.

The IRS 16, an agency of the federal government, has established a procedure granting specific entities, such as, but not limited to tax preparers or banks 14, the ability to transmit user identity information to the IRS 16. That information may include user social security numbers and other identity information. The IRS 16 in turn responds with an acknowledgement verifying the accuracy of the user information or rejecting inaccurate information. At this time, the only entities granted this ability are tax return preparers and banks. If those identities are verified, the IRS 16 may transmit identity verification back to the tax practitioner or bank 14, indicating identities of every person on the tax return or account have been verified.

It will be appreciated that this invention contemplates that other entities and verifications may be utilized as the government grants this ability. Furthermore, it will be appreciated that the bank as used herein may include banks, credit unions, and other lending institutions.

The tax practitioner or bank 14, or other person may then create a database 18 with identification information of user 12. Alternatively, the tax practitioner or bank 14 may provide the information to another entity that creates and/or maintains a database 18. The database 18 may include, among other things, identification information of the users. The identification information may include, but not be limited to, the identification verification from the IRS 16, a pictorial representation of the user, a digital representation of the user, and/or many other types of identification information. The digital representation of the user may include a retinal scan, fingerprint, palm print, as well as many other types of identification information.

Tax practitioner or bank 14 may then create an identification device 20 for user 12. The identification device 20 may include a pictorial or digital representation of user 12, and/or other identification information of the user 12. When user's identification is to be verified, the user 12 may present the identification device 20 to a merchant or other person or entity, which may utilize a terminal 22 to verify the identification of user 12. Identification of user 12 may be verified by comparing the identification information encoded on identification device 20 with identification information from database 18. In this manner an extra level of security may be utilized to verify identification. The extra level of security may be the identification verification from a government entity, such as the IRS 16.

Identification device 20 may be a bankcard, credit card, identification card, badge, or other identification device that is capable of storing, receiving, transmitting, or otherwise conveying identification information. Database 18 may be located on a computer, server, or other device, such that it may be accessed by terminal 22 and may have information transmitted to it by a tax practitioner or bank 14 or other person, as desired.

Terminal 22 may include a point of sale terminal 26, as well as a reading system 28. The reading system 28 may be configured to receive information from identification device 20, and the point of sale terminal 26 may be a point of sale terminal currently used by merchants to conduct purchases with credit cards, bankcards, and other debit or other devices. Terminal 22 may also be another type of terminal, as known or being or may be developed in the art.

This system 10 may be used in conjunction with current credit cards, bankcards, debit type cards, and other methods and devices for paying for purchases as well as verifying identification. It will be appreciated that although a point of sale terminal 26 and reading device 28 are included in terminal 22, other devices and systems may be included, as desired. Alternatively, terminal 22 may not include one or more of these devices, as desired.

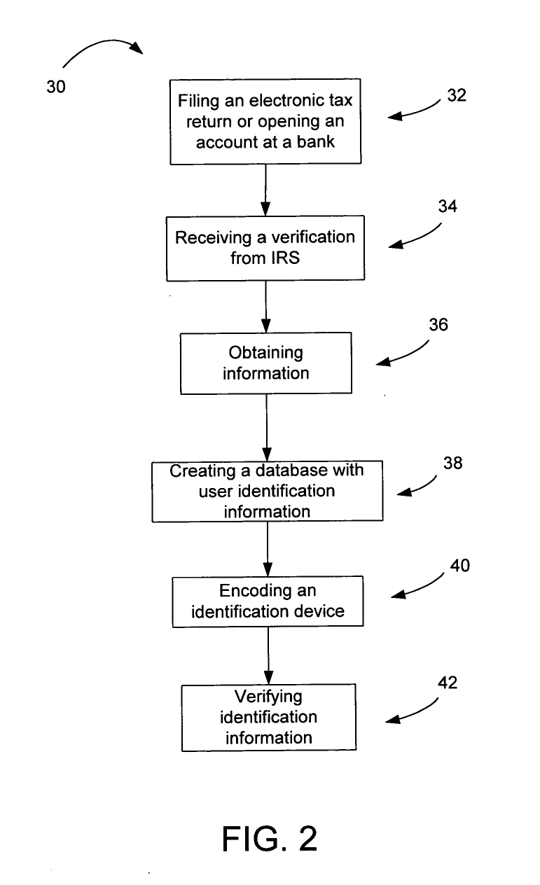

A method according to an exemplary embodiment is shown in FIG. 2, generally at 30. The method 30 may include filing an electronic tax return or opening a bank account, at 32. This filing or opening an account may include a user retaining the services of a tax practitioner or bank 14, or other tax preparer and hiring the tax preparer to file an electronic tax return for them, or to open an account at a bank. Alternatively, a user may file their own tax return and authorize the verification from the IRS be sent to a database to be utilized when a user desires their identity to be verified.

Method 30 may include receiving a verification from the IRS, at 34. If the identities of all persons included in the electronic tax return, or the bank's identity information, are verified by the IRS, the IRS may send a verification back to the tax preparer or bank indicating that all person's identification included in the transmission has been verified.

At 36, method 30 may include obtaining digital information from the user by the tax preparer, bank or other person. This digital information may include, but not be limited to, a digital photograph, pictorial representation, retinal scan, fingerprint, or other representation, or other information, as desired. The tax preparer, bank or other person may then create a database with user identification information 38. The tax practitioner or bank may also provide information, which may include a verification of the user's social security number, digital information, and a digital representation, among others. The user identification information may include the verification from the IRS, and the information such as a digital image, pictorial image, and other information from the user. The database may be located on a server and may be accessed by the Internet, other packet switched network, or other methods, as desired.

The method 30 may also include encoding and identification device, at 40. The identification device 20 may be a bankcard, credit card, identification card, or other identification device, which may include a magnetic strip, microchip, or other configurations to store or transmit the identification information. The tax preparer, bank or other person may encode identification information including verification from the IRS, digital image, pictorial representation, or other information, as desired. Then when a user's identity is to be verified, the user may utilize the identification device by presenting it to the entity needing to verify the identification of the user. The entity may be a merchant, airport screener, or any other person or entity desiring to verify the identification of a user 12. The identification information stored, transmitted or conveyed by the identification device 20 may then be compared to the identification information stored in the database 18 to verify the identity of the user 12.

A terminal 22 or other device may be used to receive information from identification device 22 and communicate with the database 18 to compare the identification information thus verify the identification of the user. This system 10 may be incorporated within current credit card, bankcard, debit type card, identification card, and other devices to add an extra level of security of identification information. Also, this system may provide identification verification from the United States government that currently may not be available.

It will be appreciated that although a tax practitioner or bank may setup the database 18, the tax practitioner or bank 14 may merely provide the information for the database 18 such that a third party may create, maintain, etc. the database 18 for merchants and others needing identification information verification of users.

Again referring to FIG. 1, an exemplary embodiment of a system 10 may operate in the following way. The user 12 may provide tax return information, including name and social security number (SSN). The tax practitioner 14 may prepare the tax return and electronically file the tax return. If the IRS 16 verifies the name and social security number(s) of all individual(s) included on return to insure all names and social security numbers match the IRS “Master File”, the tax practitioner 14 may receive an acknowledgement from the IRS accepting return for further processing.

The IRS process may include receiving the electronic transmission of tax return data filed to the IRS, and an acknowledgement record, indicating acceptance of return for further processing or rejection. The steps taken by the IRS before sending an acceptance or rejection may include verifying the SSN for the taxpayer, spouse, and all dependents and other persons included on return. The acknowledgement verifies the identity for all individuals who are included on the tax return.

If the user wants an identification device 20, such as an identification card, identification information for that user, including the verification from the IRS and a digital picture or digital representation, may be saved to the database 18. A card may then be issued to the user containing a digital picture, digital representation, and/or identification information, among other information. The identification card may also be able to store, transmit, or otherwise convey the information without storing it. The identification information may also include authorization to access the database to obtain the identification verification information of the user. Furthermore, the present invention may be integrated with existing credit cards, bankcards and other cards, which require identification verification.

Potential entities that may benefit from the use of the present invention include:

Bank credit card and debit card operations

Merchants

Airlines and other travel industry companies

Insurance companies

Credit card companies and other independent card issuers

Employers

Municipalities

School districts

Police departments

Hospitals

Pharmacies

U.S. Immigration and Naturalization Service

Airport Security including federal screeners

Any other entity that desires identification verification

An exemplary embodiment of the system may be utilized in the following way. A user 12 may enlist the help or services of a tax practitioner 14 or other person to have their taxes prepared. The tax practitioner 14 or other person may prepare the tax return and file the tax return electronically with the IRS 16. The IRS 16 may verify the social security number for the taxpayer, spouse, and all dependants and other persons included on the tax return as a part of the process to acknowledge the return. The acknowledgement may be a type of verification of the identities of all persons included on the tax return.

The tax practitioner 14 may then receive an acknowledgement from the IRS 16 accepting the tax return for further processing once the IRS verifies the name and the social security number of all individuals included on the return. The tax practitioner or bank 14 may then capture a digital image or other representation of all individuals included on the return. These digital images or other representations may then be stored in the database along with the verification from the IRS and other identification verification information. The tax practitioner or bank 14 or service thereof then may issue an identification device, such as a card, to each person who wants an identity verification device and who has been included on an electronically filed tax return. Alternatively, various embodiments of the identification system may be integrated with existing systems, credit cards, bankcards and other cards, which require identification verification.

The user may then use the identification device, and merchants and other entities that require identification verification may access, for a fee, the database to verify identification information of the user. The identification verification information may include, but not be limited to, the digital picture or representation of the user from the database, and the verification from the IRS.

Once engaged to electronically file an individual's tax return to the IRS, the Electronic Return Originator 14 (or tax practitioner) may observe and verify the individual's identification card issued by the Social Security Administration, a division of the U.S. government, bearing the individual's social security number, and may enter the observed name and number into a computer data file. The Electronic Return Originator 14 may be responsible for accurately entering into a computer data file the data required for completing the individual's tax return using a commercially available computer program written for the purpose of receiving individual taxpayer data and converting it to the electronic file format required by the IRS 16, and transmitting that data file to the IRS via data communication lines, or other means.

Elements of data required for completing the user's tax return data file may include the individual's name and social security number. Once all of the required data has been entered into the computer data file, the data file may be converted into the format required by the IRS, using commercially available computer programs written for the purpose of receiving individual taxpayer data and converting it to the electronic file format required by the IRS.

The Electronic Return Originator 14 may then transmit the user's tax return data file to the IRS over data transmission lines. The IRS, upon receiving the data file comprising the individual's tax return, may read the file and verify the accuracy of data included in the data file. If the data does not agree with government records, the IRS may reject the data file. IRS reject code 315 states “The Primary SSN (social security number) and the Name Control for the tax document must match the corresponding data in the IRS Master File” (IRS publication 1345A (Rev. 12-01). p 92). The IRS Master File is the Social Security Administration record of the social security number issued to the individual, if the primary social security number and the name control for the taxpayer individual do not match the IRS Master File, the tax return data file may be rejected.

If the tax return data file is not rejected by the IRS, the tax return data file may be accepted by the IRS for further processing. When the tax return data file is accepted for further processing by the IRS, an acknowledgement of that acceptance may be transmitted back to the Electronic Return Originator. The Electronic Return Originator may then independently verify the identity of the taxpayer individual as well as others included on the tax return.

Upon receipt of the individual's acknowledgment record accepting the tax return data file for further processing, the Electronic Return Originator may record an digital image or other representation of the individual and save the image file in a computer database along with the acknowledgement from the IRS, and other information.

To verify the identity of a user, the merchant may scan a card, information may then be sent from the database to the merchant at the terminal. The merchant may optionally request a digital image or representation of the user be downloaded to be used to match the digital image on the identification device. The merchant may receive verification information from the database that includes the acknowledgement from the IRS. Therefore, the identity verification may include an identifier from the IRS that this person is who they purport to be.

During the IRS's regular course of business, they may check the social security number and identity of everyone filing an electronic tax return. The identity verification device and/or information may be created by the tax practitioner or bank or other person or entity, and may include the identifying information, including the digital representation on the front of the card, and the user's other information encoded on a magnetic strip, or other method of storing and/or transmitting information. The entry in the database may include an entry that the IRS has verified the user's information and deemed it to be correct.

The merchant or other entity requiring identification verification information may also request that the digital representation, or other user information, be sent to compare to the information received from the identification device. Furthermore, bankcard ATMs, or other entities utilizing cameras, could use the digital representation, and/or other information to match user characteristics with the stored information in the database to verify identification.

Another exemplary embodiment of the system may be utilized by substituting the services of a bank 14 to open a deposit account or loan account or other type of account instead of enlisting the services of a tax practitioner 14 to prepare a user's 12 tax return, with the bank completing the procedures performed by the tax preparer 14 in the previous embodiments. Similarly, a bank 14, may transmit identity information of the user 12 to the IRS 16, which in turn will either acknowledge or reject the transmission. At this time, the only entities 12 granted the ability to verify user 12 identity information are tax return preparers and banks.

Exemplary embodiments may provide a very useful identification verification that no other system may utilize, namely a verification by a government entity that the user's SSN has been verified. The user's SSN or other confidential information would not have to be disclosed or even included in the database, only that the user's SSN had been verified by the IRS. No user confidential information would need to be disclosed to the merchant or other entity requiring identification verification.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the drawings and description are illustrative and not meant to be a limitation thereof.

1. An identification system, comprising:
a database comprising user identification information including a verification from the Internal Revenue Service, the verification comprising an acknowledgement record from the Internal Revenue Service's master file that the user's tax return data was previously accepted by the Internal Revenue Service for further processing;
an identification device configured to transmit said user identification information; and
a terminal configured to receive said identification information from said identification device, and to communicate with said database;
wherein said identification information from said identification device and said database are compared to verify the identity of the user.

2. The system of claim 1, wherein said identification information further comprises a pictorial representation of the user, name, date of birth, hair color, eye color, height or weight of the user.

3. The system of claim 1, wherein said identification information further comprises a digital representation of the user.

4. The system of claim 3, wherein said digital representation is a digital picture, fingerprint, or retinal scan.

5. The system of claim 1, wherein said identification device comprises magnetic material.

6. The system of claim 1, wherein said identification device comprises a microchip.

7. The system of claim 1, wherein said terminal comprises:
a point of sale terminal; and
a reading device configured to receive said user identification information from said identification device.

8. The system of claim 1, wherein said identification device is a bankcard, credit card, or identification card.

9. A method of verifying identification of a user, comprising:
providing a database comprising user identification information, wherein said identification information comprises a verification created by the Internal Revenue Service, the verification comprising a record from the Internal Revenue Service acknowledging that the user's tax return data was accepted by the Internal Revenue Service for further processing;
issuing an identification device having said user identification information thereon; and
comparing said one or more user identification information on said identification device to said user identification information in said database to verify identification of the user.

10. The method of claim 9, wherein providing a database comprises filing an electronic tax return for the user or opening an account by a bank.

11. The method of claim 9, wherein providing a database comprises receiving a verification of the identity of the user from the Internal Revenue Service.

12. The method of claim 9, further comprising obtaining a digital representation of the user.

13. The method of claim 9, wherein said comparing is accomplished at least in part by a terminal.

14. An identification verification system, comprising:
a database comprising user identification information comprising a verification from a government entity and digital information of a user, the verification comprising a record from the government entity to acknowledge that the user's tax return data was verified by the government entity;
an identification device encoded with one or more of said user identification attributes; and
a terminal configured to receive said one or more user identification attributes from said identification device, and to communicate with said database;
wherein said identification attributes from said identification device and said database are compared to verify the identity of the user.

15. The system of claim 14, wherein said government entity is the Internal Revenue Service.

16. The system of claim 14, wherein said identification attributes further comprises a pictorial representation of the user.

17. The system of claim 14, wherein said identification attributes further comprises a digital representation of the user. 18. The system of claim 17, wherein said digital representation is a digital picture, fingerprint, or retinal scan.

19. The system of claim 14, wherein said identification device comprises magnetic material.

20. The system of claim 14, wherein said identification device comprises a microchip.

21. The system of claim 14, wherein said terminal comprises a reading device configured to receive said user identification attributes from said identification device.

22. The system of claim 14, wherein said identification device is a bankcard, credit card or identification card.

23. A method of verifying identification of a user, comprising:
creating a database comprising user identification attributes;
providing an identification device configured to transmit user identification attributes; and
comparing said one or more said user identification attributes from said identification device to said user identification attributes in said database to verify identification of the user,
wherein said user identification attributes include a verification created by the Internal Revenue Service and a digital representation of the user, the verification comprising an acknowledgement record from the Internal Revenue Service that the user's tax return data was previously accepted by the Internal Revenue Service for further processing.

24. The method of claim 23, wherein said digital representation of the user comprises digital picture, fingerprint, or retinal scan.

25. The method of claim 23, wherein said identification device comprises magnetic material.

26. The method of claim 23, wherein said identification device comprises a microchip.

27. The method of claim 23, wherein said comparing is accomplished at least in part by a terminal, which comprises a reading device configured to receive said user identification attributes from said identification device.

28. The method of claim 23, wherein said identification device is a bankcard, credit card, or identification card.

29. A method of verifying identification of a user where a tax return has been filed, or an account at a bank has been opened, comprising:
receiving a verification of the identity of the user from the Internal Revenue Service, the verification comprising an acknowledgement record from the Internal Revenue Service's master file that the user's tax return data was previously verified and accepted by the Internal Revenue Service;
obtaining a digital representation of the user;
creating a database of user identification information, comprising said verification from the Internal Revenue Service and said digital representation of the user;
encoding one or more of said user identification information onto an identification device; and
verifying the identity of the user by comparing said one or more user identification information on said identification device to said user identification information in said database.

30. The method of claim 29, wherein said identification device comprises magnetic material.

31. The method of claim 29, wherein said terminal comprises a point of sale terminal and a reading device configured to receive said user identification information from said identification device.

32. The method of claim 29, wherein said identification device is a bankcard, credit card, or identification card.

33. A method of verifying identity where a tax return has been filed or a bank account has been opened, comprising:
receiving an identification verification of the user from the Internal Revenue Service, the identification verification including an acknowledgement record from the Internal Revenue Service that the user's tax return data was previously verified and accepted by the Internal Revenue Service;
creating a database comprising user identification attributes, which comprises said identification verification from the Internal Revenue Service;
encoding one or more of said user identification attributes onto an identification device; and
comparing said one or more user identification attributes on said identification device to said user identification attributes in said database to verify identification of the user.

34. The method of claim 33, wherein said identification attributes further comprises a digital representation of the user.
